(19) United States
(12) Patent Application Publication
(10) Pub. No.: US 2015/0201694 A1
(43) Pub. Date: Jul. 23, 2015

(54) STRETCHABLE, FLEXIBLE ELECTRONIC PATCH FOR MONITORING IMPACTS AND OTHER EVENTS

(71) Applicant: Christopher Michael Boyce, New York, NY (US)

(72) Inventor: Christopher Michael Boyce, New York, NY (US)

(21) Appl. No.: 14/158,798

(22) Filed: Jan. 18, 2014

(51) Int. Cl. A42B 3/04; G08B 21/18

(52) U.S. Cl. CPC A42B 3/0433; G08B 21/182

(57) ABSTRACT

This invention comprises a stretchable electronic patch for monitoring impacts and other events. The stretchable, flexible electronic impact monitor patch includes geometric patterning of the substrate which enables stretching and flexing of the patch while leaving substrate regions at low strain for placement of electronic components, sensors and interconnects, maintaining electrical function during stretching and flexing. The stretchable, flexible, conformable patch enables wearability of the patch. In addition to monitoring impact events, other sensors may be incorporated for monitoring temperature, pressure, moisture, motion, location and other parameters. The patch may further possess an adhesive backing for adhering the patch to the head, the body or the object. The patch may take the form factor of a bandaid or bandage for comfortable wearing directly on the human body. The patch may also be coated to enhance comfort and also protect against moisture, water, and other environmental factors.

There is growing recognition that the head impacts incurred by child and adult athletes during certain sporting activities (football, hockey, soccer, and others) as well as by the soldier on the battlefield play a determining role in short-term and long-term injury to the brain. The dramatic occurrence and effects of traumatic brain injury (TBI) in soldiers and football players is now well documented and recognized. A strong need exists to understand the level and frequency of impact events during sports and during warfare. There has been intensive work in recent years to develop sensor systems for monitoring head (and/or body) impact in soldiers and football players, most of these efforts have been put towards helmet-mounted systems. Helmet mounted systems suffer a number of disadvantages including the fact that they monitor the helmet and not the head. It is highly desirable to have a unobtrusive, wearable impact monitor patch which can directly adhere to, as well as stretch and flex, with the body while continuously monitoring, recording and transmitting impact data during the activity. The need to monitor body position and motion during other activities is also expanding for situations as diverse as active sporting and gaming events to convalescence, rest, and sleep.

The invention comprises a flexible and stretchable electronic patch that monitors impact or other events whereby a flexible substrate is geometrically patterned to allow the substrate to undergo substantial stretching and flexing while large regions of the substrate material experiences local strains much lower than the macroscopic applied strain. The invention described builds on the invention of M. C. Boyce, S. Socrate, B. Greviskes, C. M. Boyce, “ Structured material substrates for flexible, stretchable electronics”, U.S. Utility Patent Application Pub. No. US 2010/0330338 (published December 2010, filed June 2010) which was related to Provisional Patent No. 61/221,542 of June 2009 and No. 61/265,256 (November 2009) and No. 61/320,747 (April 2010). The geometric patterning of the substrate facilitates continuous low strain domains (LSDs) throughout the substrate—where low strain domains are defined as regions that experience strain levels (magnitude) lower than the macroscopic applied strain. Conventional electronic components can be mounted to the LSDs, and conventional metal traces can be routed through the LSDs, dramatically reducing the stresses transmitted to the components and traces by the substrate during stretching and flexing, and therefore reducing the potential for component debonding, trace cracking, and circuit failure. The geometrically patterned strain relief features (SRFs) are dispersed either regularly or irregularly throughout the substrate. The geometrically patterned SRF regions form “hinge-like” domains. During macroscopic deformation, the SRFs rotate, translate, open, close, or otherwise change shape, causing the “hinge-like” regions to deform, and the remaining larger LSD substrate regions to primarily rotate and translate. The SRFs are designed such that the “hinge-like” regions also exhibit relatively small strain compared to the macroscopic applied strain and thus enable conductive traces, such as copper or gold, to run through the hinges and maintain function during stretching, flexing and twisting of the patch. The substrate can be multilayered to enable running conductive traces, ground layers, vias, and/or components on/in multiple layers through the thickness of the overall substrate. The geometric patterning can be designed to enable different stretching, flexing and twisting, providing uniaxial, biaxial, and multi-axial stretchability or flexibility, and the ability to conform to a variety of surface curvatures. The geometrically patterned substrate offers a means of packaging complex multi-layered electronics designs for monitoring impact (and other) events onto a stretchable and flexible substrate enabling the device to dynamically stretch, bend, twist, and conform to arbitrary shapes. The stretchable, flexible geometrically structure electronics can be fabricated using the same technologies for conventional flexible circuit boards where the stretch-enabling patterning can be imparted at different stages in the fabrication process and can also be fabricated using emerging materials and fabrication methods.

The Stretchable Electronic Head Impact Monitor (SEHIM) of this invention comprises the stretchable, flexible substrate described above with multiple LSDs for placement of electronic components (e.g., accelerometers, gyroscopes, pressure temperature, gas and fluid sensors, microprocessors, transceivers, GPS, clocks, actuators, vias, and batteries (or other energy source)) and multiple patterned hinge-like regions bridging the LSDs which enable the routing of conducting interconnecting traces. The SEHIM patch can take the form factor of a bandaid or bandage or other such wearable form factor. The geometric patterning provides stretch, flex and twist to conform to a body and stretch, flex and twist to move or deform with a body. One embodiment of the SEHIM is pictured in FIG. 1 and in FIG. 2 next to a standard Band-Aid (approximately 2.25 inches by 0.7 inches). This embodiment presents a two-layered electronic design. The SEHIM detects impact accelerations, using a 3-axis accelerometer and processes the raw acceleration data in the microprocessor. The processed data is stored in the microprocessor and later (or potentially in real time) transmitted via the Bluetooth to a smart phone, tablet or computer. This embodiment encompasses wireless communication but wired communication may be desirable in some applications and can be accommodated by this invention. This particular embodiment of the SEHIM is designed with three primary low strain domains (LSD), interconnected with two columns of hinge-like strain relief features (SRF). The battery is located on the left side and, in this embodiment, is decoupled mechanically from the rest of the SEHIM by the left side column of SRFs, which provide differential stretching, flexing and twisting between the battery and rest of the device. In the center low strain domain (LSD) are the microprocessor, oscillator and two bus transceivers, which are also isolated from the Bluetooth LSDs with the right side column of SRFs. In the upper right hand corner of this embodiment of the SEHIM, the accelerometer is further isolated from the rest of the SEHIM by a localized LSD with surrounding SRFs. All of the mechanical decoupling is being accomplished in the design while robust electrical interconnection is maintained using conventional 5-mil copper traces for routing signals. The traces are routed through the patterned hinges in a manner to provide minimal straining of the conductive traces during stretching, bending and twisting of the SEHIM. This strain minimization is accomplished by the engineered designs of the SRFs.

Nonlinear finite element analysis of the stretching, flexing and twisting of this embodiment of the SEHIM verified the ability to stretch, flex and twist while maintaining its electrical performance and structural integrity. FIG. 3 shows the detailed finite element model of the SEHIM with the dielectric layers (Kapton), copper trace layers and components. The model was stretched 5% (to a distance 105% of its original length), bent 180 degrees, and twisted 40 degrees. Results showed that SEHIM could be stretched, bent and twisted with the traces and components at low strains to maintain electrical function. In all cases there was effectively no strain on the components and solder joints. Thus, the SEHIM demonstrated the ability to behave with the same wearability as a bandaid, while maintaining its system performance. The SEHIM can take many different geometric designs depending on the desired stretching, bending, and twisting while also packing the needed electronics. (FIGS. 6 and 7)

The embodiment of the SEHIM shown in FIGS. 1 and 2 was fabricated and assembled using commercial flex circuit board manufacturing and geometric patterning was achieved using laser cutting (other methods such as routing can also achieve the geometric patterning). FIG. 4 depicts the fabricated SEHIM next to a bandaid and also depicts a ruler for scale. FIG. 5 depicts the bending, stretching, and twisting of the fabricated SEHIM and also shows the SEHIM attached to a human head. The patterned substrate of the SEHIM enables the conformation, the stretching, the flexing and the twisting of the SEHIM and hence the wearability of the SEHIM. The SEHIM can take on many different geometrically patterned substrate forms, which can be tailored to meet the desired stretch/flex/twist and to fit the needed electronics. FIGS. 6 and 7 show a few representative geometric designs. The SEHIM can also possess an adhesive backing for direct adhesion to the head, body or object. The SEHIM can also be coated to provide both added comfort and protection against moisture, water, and other environmental factors. The SEHIM can also contain other sensors including gyroscopes, temperature and pressure sensors, moisture sensors, clocks, chemical and/or biological sensors, etc.

### ALL FIGURES SHOWN IN DRAWINGS FILE

FIG. 1: One representative geometrically structured substrate with a bandaid form factor, showing large low strain domains for components and patterned hinge-like strain relief features for routing traces and for enabling stretching, flexing and twisting of the electronic patch.

FIG. 2: One embodiment of a geometric structure design of the Stretchable Electronic Head Impact Monitor patch in the form factor of a bandaid and basic layout of electronic components needed for the measurement, recording and transmission of impact events.

FIG. 3: Finite element simulations of the representative embodiment of the Stretchable Electronic Head Impact Monitor patch undergoing stretching, bending and twisting which reveals the strains in the traces and components to be negligible and hence electronic function is unaffected by stretching, bending or twisting.

FIG. 4: Fabricated version of one embodiment of the Stretchable Electronic Head Impact Monitor shown above a bandaid with a ruler also shown for scale.

FIG. 5. Bending, stretching, twisting of the embodiment of the Stretchable Electronic Head Impact Monitor; SEHIM embodiment depicted on a human head.

FIG. 6: The Stretchable Electronic Head Impact Monitor can take on many different geometrically patterned substrate forms to enable desired stretching, flexing and twisting where the size of the low strain domains can be altered and the geometry and positioning of the hinge-like regions can also take many different forms.

FIG. 7: The Stretchable Electronic Head Impact Monitor patch can also take on different overall aspect ratios where a square bandage form factor is shown above.

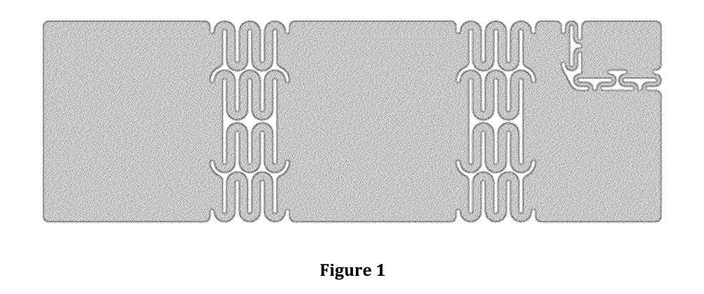

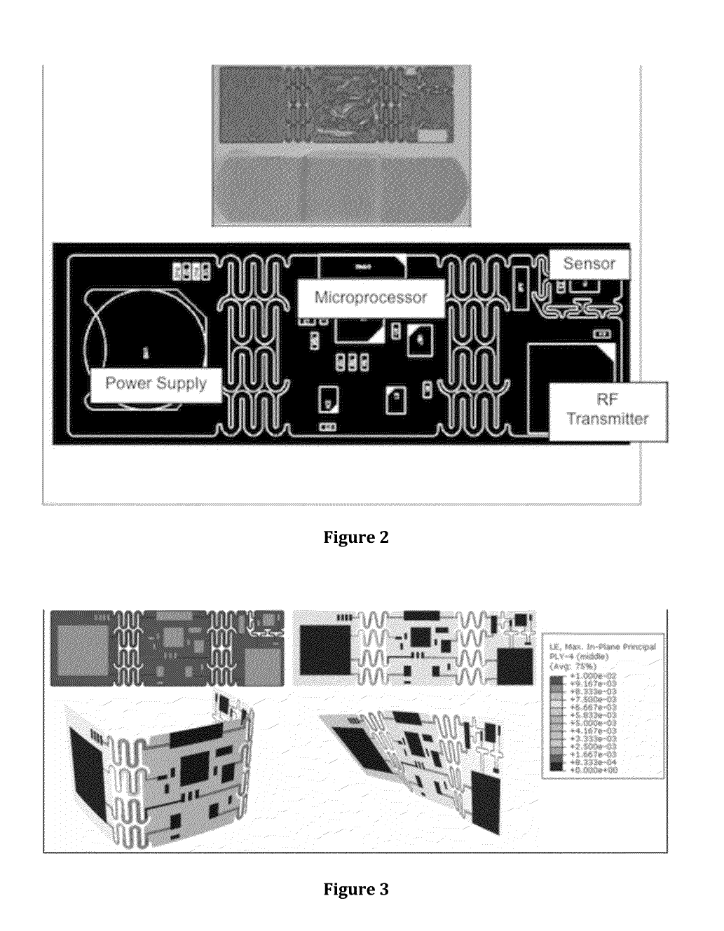

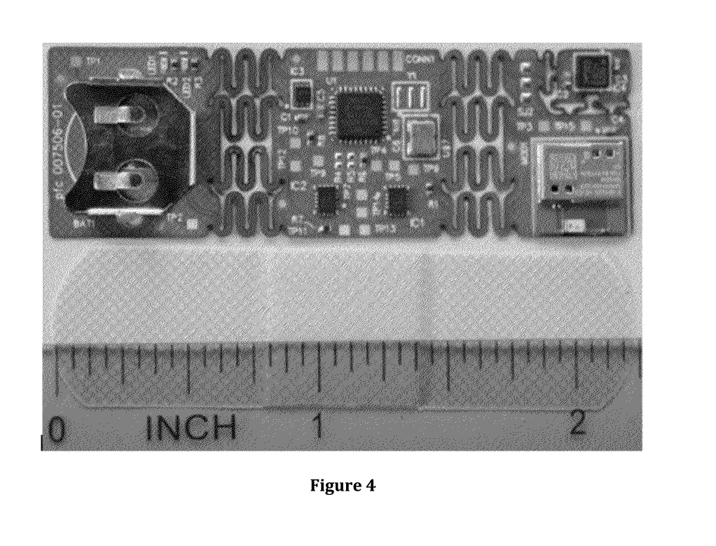

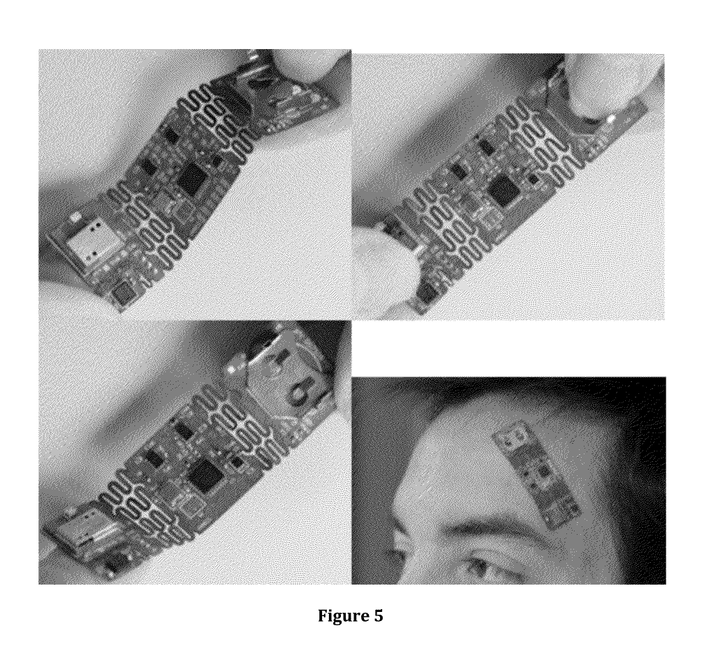

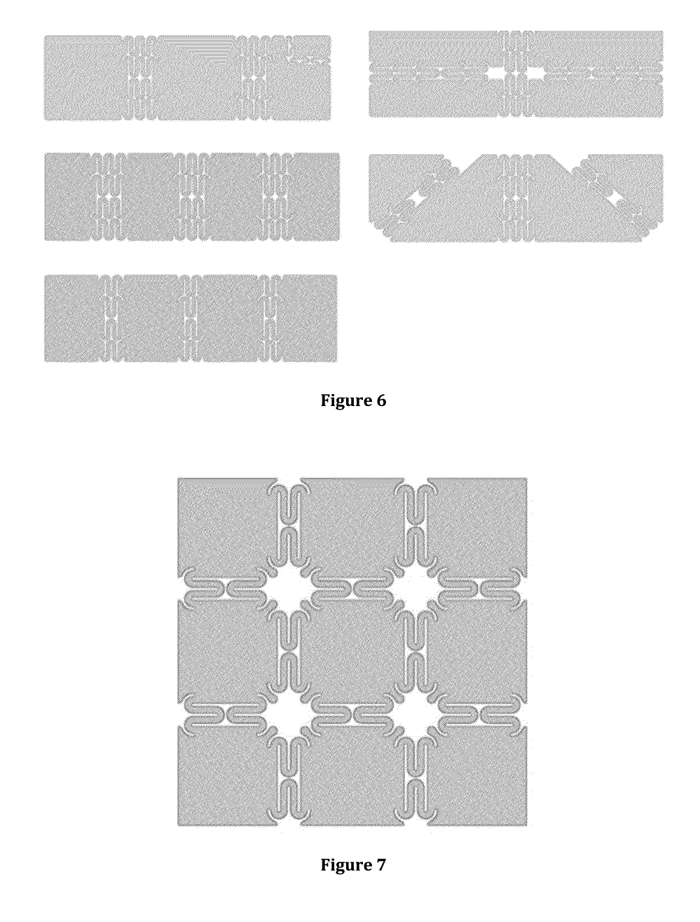

1. A stretchable, flexible patch with electronics incorporated comprising,
A geometrically patterned substrate that contains regions of very low strain (low strain domains, LSDs) bridged by hinge-like “strain relief features” (SRFs) which also contain low strain regions and enable the stretching, flexing and twisting of the patch while maintaining continuous low strain regions for mounting electronic components and routing traces.

2. The patch of claim 1 where the electronic components, sensors, and interconnects of the patch monitor, record, process and/or transmit events of interest (such as accelerometers and gyroscopes for impact events, temperature sensors for temperature and/or temperature gradients, pressure sensors, moisture sensors, chemical sensors)

3. The stretchable, flexible electronic patch of claim 1 comprised for sensing and/or monitoring impact events where the sensors are accelerometers (1,2, or 3 axes), gyroscopes, and/or pressure sensors.

4. The stretchable, flexible electronic patch of claim 1 comprised for sensing and/or monitoring and/or controlling ongoing events where the sensors monitor temperature, temperature gradients, motion, position, environmental or chemical levels, or other such information.

5. The stretchable, flexible electronic patch of claim 1 comprised for sensing events or other information including mounting multiple distributed sensors for obtaining spatial and/or temporal distribution in the data and/or multiple sensors sensing different information and data.

6. The stretchable, flexible electronic patch of claim 1 including wired or wireless communication, such as a Bluetooth module or a wi-fi module or other transmission module, transmitting and/or receiving information to/from another device.

7. The stretchable, flexible electronic patch of claim 1 with power and energy sources including batteries, wired or wireless rechargeable batteries, photovoltaics, thermoelectrics, or energy harvesters.

8. The stretchable, flexible electronic patch of claim 1 with an adhesive backing for directly adhering to a head, a body, or an object.

9. The stretchable, flexible electronic patch of claim 1 contained in an adhesive or a stretchable, flexible sleeve for adhering or attaching to a head, a body, or an object.

10. The stretchable, flexible electronic patch of claim 1 coated with a coating for protection against the elements (water, moisture, dirt, other) and/or for increased comfort to the wearer.

11. The stretchable, flexible electronic patch of claim 1 worn on the body.

12. The stretchable, flexible electronic patch of claim 1 for attachment to or on or an object, or embedded in an object.

13. The stretchable, flexible electronic patch of claim 1 in the form factor of a rectangular or a square or a triangular or other polygon or circular or elliptical or other geometric shape bandage.

14. The stretchable, flexible electronic patch of claim 1 in the form factor that is or contains any combination of rectangles, triangles, circles, ellipses or other form factors.

15. The stretchable, flexible electronic patch of claim 1 with different geometric patterning of different numbers and shapes and orientations of low strain domains, different numbers and orientation of geometrically structured hinge-like domains, and different geometries of hinge-like domains.

16. The stretchable, flexible electronic patch of claim 1 as a stretchable, flexible programmable circuit board for arbitrary applications.

17. The stretchable, flexible electronic patch of claim 1 fabricated using current flex circuit manufacturing methods and materials.

18. The stretchable, flexible electronic patch of claim 1 comprising a single or a multi-layered electronic circuit design

19. The stretchable, flexible electronic patch of claim 1 where the polymer layers are current flex manufacturing polymers such as Kapton, polyimides, polyamides, polyesters, or other as well as elastomers such as silicone rubbers (PDMS) or polyurethanes or other elastomers.

20. The stretchable, flexible electronic patch of claim 1 where the interconnects are metals that have high electrical conductivity, such as copper or gold, or where the interconnects are emerging stretchable electronic materials and stretchable conductive inks and materials.
